(19) United States
(12) Patent Application Publication
(10) Pub. No.: US 2002/0176579 A1
(43) Pub. Date: Nov. 28, 2002

(54) Location-based services using wireless hotspot technology

(76) Inventors: Nikhil M. Deshpande, Beaverton, OR (US); Ramgopal K. Reddy, Portland, OR (US); Timothy Chen, Portland, OR (US); Stephen Dohrmann, Hillsboro, OR (US); Robert C. Knauerhase, Portland, OR (US)

Correspondence Address: PILLSBURY WINTHROP, LLP, P.O. BOX 10500, MCLEAN, VA, 22102, US

(21) Appl. No.: 09/863,516

(22) Filed: May 24, 2001

(51) Int. Cl. H04L 9/00

(52) U.S. Cl. 380/270

(57) ABSTRACT

According to an embodiment, a method of providing location-based services to a wireless device using a hotspot access point is provided comprising establishing a connection between the wireless device and the hotspot access point, and providing information associated with the physical location of the hotspot access point to the wireless device. There is also provided a method of securing services provided through a hotspot access point, a method of billing services provided through a hotspot access point and a method of providing access to an application through a hotspot access point.

### BACKGROUND

1. Field of the Invention

This invention relates in general to the field of location-based services. Particularly, aspects of this invention pertain to location-based services using wireless hotspot technology such as Bluetooth and wireless local area networks.

2. General Background and Related Art

Wireless technology has become ubiquitous. It has reached all over the world and found numerous applications ranging from the traditional wireless telephone to wireless computerized shelf price labeling to wireless data entry units for tracking packages. Such wireless technology comes in many forms including the well-known traditional cellular network for phones, wireless local area network systems (WLANs) and Bluetooth wireless technology.

Wireless local area network systems are flexible data communication systems implemented as an extension to, or as an alternative for, a local area network connected by traditional cabling. WLANs use electromagnetic airwaves (radio) to communicate information from one point to another within the local area network without relying on any physical connection. In a typical WLAN configuration, a transceiver, called an access point, connects to the wired network from a fixed location using standard cabling. The access point receives, buffers, and transmits data between the WLAN and the wired network infrastructure and operates typically over a limited spatial range. End users access the WLAN through wireless LAN adapters, which may be implemented as PCMCIA cards in laptop computers, as ISA or PCI adapters in desktop computers, or as fully integrated devices within hand-held computers. WLAN adapters provide an interface between the client network operating system and the local area network via the airwaves and access points.

Bluetooth is a relatively new form of wireless technology. Bluetooth is a wireless technology standard and specification for small-form factor, short range radio links between electronic devices. The Bluetooth radio is built into a small microchip and operates in a globally available frequency band. Through the Bluetooth technology, Bluetooth enabled devices will be able to communicate with each other when they are in close proximity with each other without requiring traditional physical connections such as cabling. Consequently, the Bluetooth technology enables simple, spontaneous wireless connectivity and acts as a complement to WLANs that are designed to provide continuous connectivity via standard wired LAN features and functionality.

With the growth in and prevalence of wireless technology, a new application of wireless technology has emerged: location-based services. Location-based services comprise supplying specific information and services to a wireless device and/or the user of a wireless device in relation to the wireless device's (and consequently, in most cases, the user's) spatial location. Well-known methods in the art for such spatial location comprise using global positioning systems (GPS) and cellular base station triangulation techniques. Once a device's location is known, the physical location of the user/device can be determined in association with known geographical mapping techniques. Such physical location information can then be used, e.g., to find the user/device in emergency situations, to aid the user/device in travelling by providing maps or directions to the user/device or to provide physical location specific information such as nearby hotels, banks, etc. to the user/device. See, e.g., U.S. Pat. No. 6,199,010 to Richton.

Traditional spatial location methods however suffer limitations. For example, in the case of cellular base station triangulation, special equipment is often required at each base station to triangulate a cellular user/device thereby increasing costs. GPS often does not work inside buildings or in other situations where positioning satellites are out of sight or otherwise inaccessible.

Further, location-based services have traditionally suffered from bandwith problems. Traditional cellular systems have relatively low bandwith and therefore the amount and type of information that could be provided to a user/device has been limited by such considerations.

Accordingly, there is a need in the art for improved location-based services using wireless technology. Therefore, it would be advantageous to provide location-based services using wireless hotspot technology.

### BRIEF DESCRIPTION OF THE DRAWINGS

Exemplary embodiments of the invention are illustrated in the accompanying drawings in which like references indicate similar or corresponding elements and in which:

FIG. 1 illustrates a hardware architecture of a public embodiment of the invention;

FIG. 2 illustrates a hardware architecture of a business embodiment of the invention;

FIG. 3 illustrates data flows in the public embodiment of the invention shown in FIG. 1;

FIG. 4 illustrates data flows in the business embodiment of the invention shown in FIG. 2; and

FIGS. 5(a), 5(b) and 5(c) are a flow diagram illustrating in generalized fashion the method for providing location-based services according to embodiments of the invention.

### DETAILED DESCRIPTION

A method, system and computer program product for location-based services using wireless hotspot technology is provided. A method of providing location-based services to a wireless device using a hotspot access point is provided comprising establishing a connection between the wireless device and the hotspot access point, and providing information associated with the physical location of the hotspot access point to the wireless device. There is also provided a method of securing services provided through a hotspot access point, comprising establishing a connection between a wireless device and the hotspot access point, determining user/device identification information associated with the wireless device, identifying a mode of security for the services using the user/device identification information, the mode having associated therewith routing identification information, and providing the services according to the mode of security using the routing identification information through the hotspot access point to the wireless device. Further, a method of billing services provided through a hotspot access point is provided, comprising establishing a connection between a wireless device and the hotspot access point, determining user/device identification information associated with the wireless device, and billing usage of the services through the access point by the wireless device according to a mode of billing identified by the user/device identification information. And, there is provided a method of providing access to an application through a hotspot access point, comprising establishing a connection between a wireless device and the hotspot access point, determining user/device identification information associated with the wireless device, and synchronizing the wireless device to any one of an e-mail, calendar, task list or contact application associated with the user/device identification information.

There is also provided a system of providing location-based services to a wireless device using a hotspot access point, comprising the hotspot access point to establish a connection between the wireless device and a hotspot access point network, and location-based services server to provide information associated with the physical location of the hotspot access point to the wireless device.

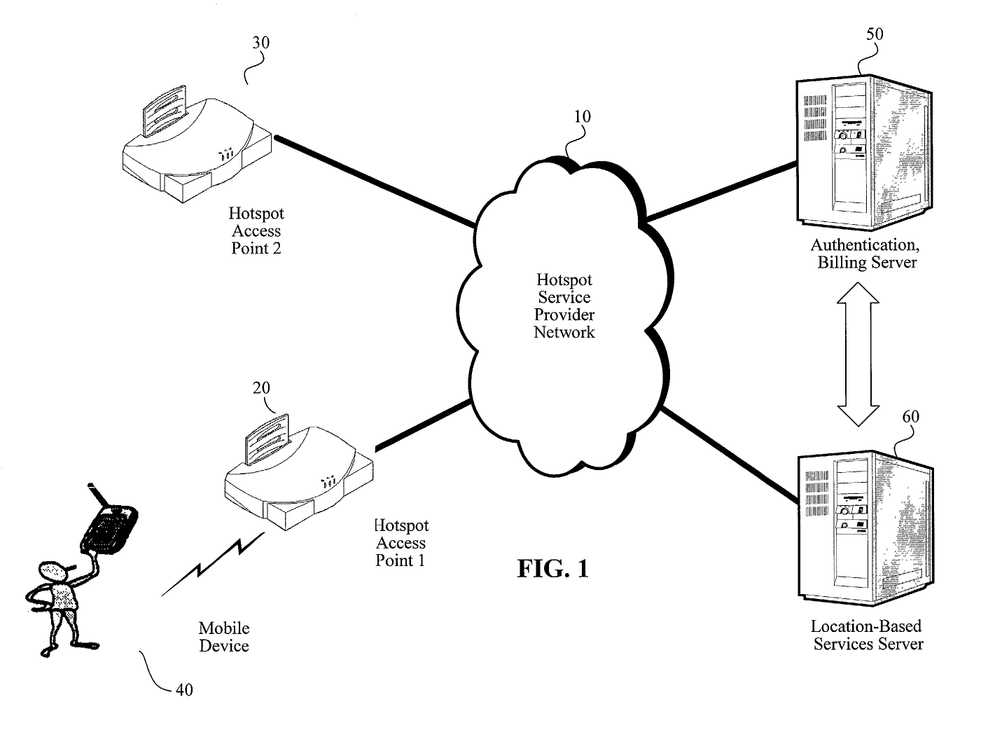

Further, a computer program product including computer program code to cause a computer to perform a method of providing location-based services to a wireless device using a hotspot access point is provided, the method comprising establishing a connection between the wireless device and the hotspot access point, and providing information associated with the physical location of the hotspot access point to the wireless device. There is also provided a computer program product including computer program code to cause a computer to perform a method of securing services provided through a hotspot access point, the method comprising establishing a connection between a wireless device and the hotspot access point, determining user/device identification information associated with the wireless device, identifying a mode of security for the services using the user/device identification information, the mode having associated therewith routing identification information, and providing the services according to the mode of security using the routing identification information through the hotspot access point to the wireless device. And, there is provided a computer program product including computer program code to cause a computer to perform a method of billing services provided through a hotspot access point, the method comprising establishing a connection between a wireless device and the hotspot access point, determining user/device identification information associated with the wireless device, and billing usage of the services through the access point by the wireless device according to a mode of billing identified by the user/device identification information. Referring to FIG. 1, a schematic overview of the architecture of a public embodiment of the invention is shown. According to this embodiment, a hotspot service provider supplies location-based services to the public via its hotspot service provider network 10. The hotspot service provider supplies one or more hotspot access points 20, 30 connected to the hotspot service provider's network. In this embodiment, a hotspot is a location where a wireless access point (e.g. a radio unit that connects devices wirelessly to a hotspot service provider's network such as Intel Corporation's PRO/Wireless 2011 LAN Access Point device) is strategically located for providing wireless devices and users of such devices, if any, access to the hotspot service provider's network. The hotspot service provider's network may in turn provide access to the Internet or other electronic services (e.g. a corporate intranet). Typical hotspots are locations in airports, hotels, restaurants, stadiums, etc. where users/devices in the public may want to make a high bandwith connection to a hotspot service provider's network (and any other connected networks such as the Internet) and obtain services.

A user/device makes a connection with the hotspot service provider network by having the mobile wireless device 40 come into the range of a hotspot access point. The mobile wireless device would recognize that an access point is available and may choose to register for the services supplied by the hotspot access point if the device is configured to accept such services. If the device registers with the hotspot service provider network via the access point, the hotspot service provider network confirms the user/device's access privileges by confirming authorization with one or more authentication servers 50. If authorized, the hotspot service provider may also charge for all or part of the services provided to the device via one or more billing servers 50. Once authorized, the device may then request or accept location-based services that are implemented using one or more location-based services servers 60 and supplied through access point and the hotspot service provider network.

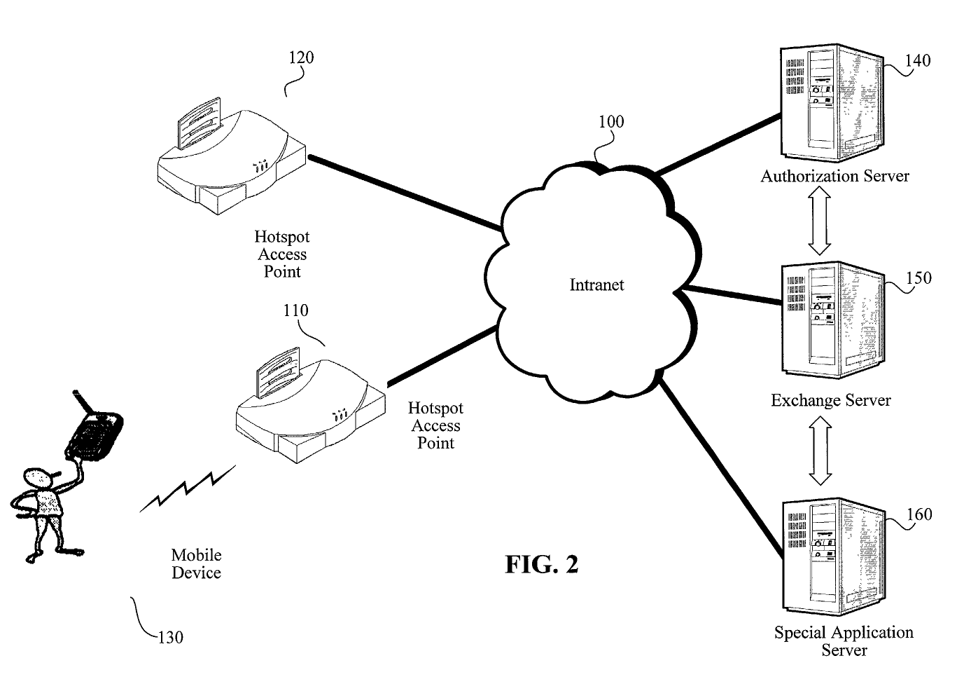

Referring to FIG. 2, a schematic overview of the architecture of a business embodiment of the invention is shown. In this embodiment, location-based services are supplied in a business setting via an intranet 100. The intranet is connected to one or more hotspot access points 110, 120 which supply to wireless devices access to the intranet (and the location-based services). In this embodiment, a hotspot is a location where a wireless access point (e.g. a radio unit that connects devices wirelessly to a hotspot service provider's network such as Intel Corporation's PRO/Wireless 2011 LAN Access Point device) is strategically located for providing wireless devices and users of such devices, if any, access to the intranet. The intranet or access point may also provide access to the Internet or other electronic services. Typical hotspots are locations at building entrances, hallways, cafeterias, etc. where users/devices may want to make a high bandwith connection to the intranet (and any other connected networks such as the Internet) and obtain services.

A user/device makes a connection with the intranet by having the mobile wireless device 130 come into the range of a hotspot access point. The mobile device would recognize that an access point is available and may choose to register for the services supplied by the hotspot access point if so configured to accept or request such services. If the device registers with the intranet via the access point, the user/device's access privileges are confirmed with one or more authentication servers 140. Once authorized, the device may then request or accept e-mail, contact, task list, calendar and other standard application services such as synchronization via one or more exchange servers 150 and other services such as location-based services implemented using one or more special application servers 160 and supplied through the access point and the intranet.

As will be apparent to those skilled in the art, a mobile device may be any of a variety of devices ranging from cell phones to laptops to hand-held computers (such as personal digital assistants (PDAs)). Moreover, a mobile device in this case may also be embedded in other products or machines. For example, the mobile device may be embedded within an automobile, boat or any other vehicle. Accordingly, a device need not be in “physical” possession of an end-user individual. Further, as will be apparent to those skilled in the art, the network, intranet, access point(s) and one or more of the described servers may be eliminated, integrated or further separated/subdivided as desired in an actual implementation. For example, there may be no hotspot service provider network per se if all the server functionality is incorporated into the access point.

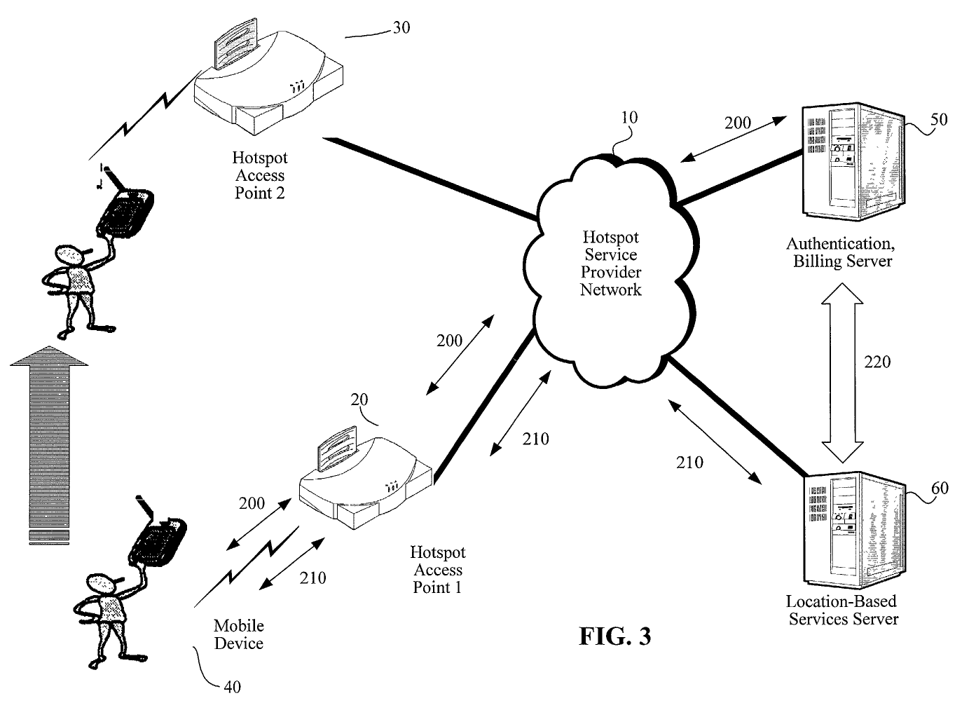

Referring to FIG. 3, a scenario of supplying location-based services along with associated data flows in accordance to the public embodiment of the invention is described. In this scenario, a user desires to locate a smoking lounge near the user's present physical location in an airport that has access points provided by a hotspot service provider, although as should be apparent to those skilled in the art other location-based information (and any other perhaps non-location-based but relevant information) could be provided to the user/device. So, when the user/device enters the range of a hotspot access point 20, the operating device 40 discovers from transmissions emitted from the access point that the device may register for services supplied through the access point (equally the device could send out transmissions to which an access point could respond by accepting a request for or offering such services if authorized).

If the device is configured to register for services supplied through the access point (e.g. the device is authorized to access the services whether by the user or manufacturer of the device pre-configuring the device to request or accept all such services, a portion of such services depending on specific criteria or all or some of the services after inquiry of the user whether to request or accept all or specific services supplied), the device and the access point will begin handshaking 200 to establish a connection wherein the device and user is authorized via the authentication server(s) 50 for access to the hotspot service provider's services. In an embodiment, a user/device is required to provide identification information such as a user name to determine whether and what types of service may be provided and authentication information such as a password to confirm proper usage of the services. As will be apparent to those skilled in the art, such identification and/or authentication information may be pre-configured into the device or may be selectively provided by the user of the device. Further, certain users/devices may be able to connect with and request or accept services from the hotspot service provider network without identification and/or authentication such as no-charge Internet access or location-based services supported by advertisements. Optionally, some or all of the information exchanged during handshaking may be encrypted to protect identification and/or authentication information transmitted during handshaking. Upon authentication, subsequent handshaking of the device with another access point will not require the user/device to supply identification and/or authentication information for access to services provided there is a current connection between the device and the hotspot service provider's network.

If the user/device is authenticated, there may also be provided one or more modes on the device or on the hotspot service provider network for providing appropriate security. Based on the mode, an appropriate level of security may be provided. In an embodiment, unique user/device identification information (such as an International Mobile Subscriber Identity (IMSI) string used in mobile telephone networks) is selectively associated with a mode by the user or the network (or perhaps automatically by default or based upon criteria) and each mode has its own routing identification (for example, a unique IP address for each mode). So, in operation, the user/device identification information identifies the desired security mode and upon identification of the relevant mode, communications are routed through the mode's unique IP address using appropriate security (e.g. encryption, firewalls, etc.) to the mode identified. In an embodiment, three modes are provided: a business or private mode wherein high encryption is used to essentially create a virtual private network (VPN) and that would be most useful to business or individual users/devices requiring high security (e.g. accessing a corporate LAN); a public mode wherein low security is provided and that would be most useful to service subscribers who require low security or users/devices provided access to the hotspot service provider network freely; and a personal mode wherein low to medium security is provided depending on the usage of the connection (e.g. simple browsing vs. banking) and that would be most useful to service subscribers or users/devices of the hotspot service provider network provided free access but requiring some measure of security.

If the user/device is authenticated, usage of the services may also be charged and billed through one or more billing servers 50 perhaps depending on the type of user/device accessing the hotspot service provider network and the types of services requested or accepted from the hotspot service provider network. For example, certain connections with and services from the hotspot service provider network may not be billed while other connections and services could be billed. There may further be provided one or more modes on the device or on the hotspot service provider's network for flexible billing. Based on the mode, an appropriate party may be billed. In an embodiment, unique user/device identification information (such as an International Mobile Subscriber Identity (IMSI) string used in mobile telephone networks) is selectively associated with a mode by the user or the network (or perhaps automatically by default or based upon criteria) and each mode has its own routing identification (for example, a unique IP address for each mode). So, in operation, the user/device identification information identifies the desired billing mode and upon identification of the relevant mode, service usage is billed according to a billing profile that identifies the billed party, billing rates, etc.

In an embodiment, three modes are provided: a business or private mode, a public mode and a personal mode. In the business or private mode, a business entity is billed for user/device usage of services from a hotspot service provider network. In this mode, business arrangements are needed between the hotspot service provider network and the business entity such as direct arrangements where a business subscription with the hotspot service provider has been provided for the user/device or indirect arrangements where a personal user subscription is used for business purposes and such usage is billed to a business entity. This type of mode will be useful to business employees that need access to a hotspot service provider's services for a business purpose without having to establish an individual subscription with that hotspot service provider.

In a public mode, hotspot service provider network usage is billed to the user directly (in most cases, on a pay-per-use basis). For example, the user can make payment by credit card, debit card, pre-payment or any other present payment means or pay at a later time through an invoicing mechanism. This type of mode will be useful to individual users/devices desiring access to a hotspot service provider network where the user/device has had no previous direct or indirect subscribing relationship with the hotspot service provider and the provider has no relationship with any of user/device's other service providers.

Lastly, in a personal mode, network usage is billed as part of the bill of another of user/device's service providers. For example, the usage may be billed through a user's Internet service provider or mobile phone service provider or the usage of a mobile telephone device may be billed to the mobile phone service provider associated with that mobile telephone. In this mode, business arrangements are needed between the hotspot service provider network and the other user/device service provider to permit such billing. This type of mode will be most useful to individual users/devices desiring access to a hotspot service provider network where the user/device has had no previous direct or indirect subscribing relationship with the hotspot service provider but the provider has a relationship with one or more of user/device's other service providers.

Once authenticated and a connection is established with the hotspot service provider network, the user/device can request or accept 210 location-based services e.g. request the location of the nearest smoking lounge in the airport. In an embodiment, the user/device selectively chooses to receive all or specific location-based services. As should be apparent to those skilled in the art, the user/device may request or accept all or a portion of such services automatically or the services provided may be defined by profile information for the user/device maintained in the hotspot service provider network, preferably the authentication server(s).

Upon receiving the request or acceptance from the user/device for location-based services or automatically in other circumstances, the hotspot location-based services server(s) 60 identifies which access point the device is accessing using, for example, access point identification information associated with the connection. In an embodiment, the request or acceptance along with the access point identification information (or in other cases simply the access point identification information) is then sent to the hotspot service provider's location-based services database(s) (which is optimally combined with the hotspot location-based services server(s)) to determine the nearest smoking lounge (or other relevant location-based or perhaps non-location-based but relevant information) to the access point. Such determination can be done simply by matching the access point identification information to the physical location of that access point through a look-up in a table comprising information matching an access point's identification information and the access point's physical location. The match could provide further location-based (or non-location based but relevant) information related to the access point (and therefore the user/device's approximate physical location) or provide a link to location-based (or non-location based but relevant) information in the same or other database(s) through, for example, database keys. In an embodiment, the access point identification information is preserved for usage with other location-based services such as location-based information narrowing as described hereafter.

Once the smoking lounge(s) (or other) information is determined, it is then downloaded 210 to the device where it may be displayed for the user or otherwise used by the device. Such information can include maps, text directions, photos, descriptions, hours, etc. or perhaps other non-location based information such as advertisements. In an embodiment, the types and usage of services including location-based services supplied to the device can be configured based on the user/device accessing the hotspot service provider's network through the exchange of profile information 220 between the authentication/billing server(s) and the location-based services server(s). Such profile information details the services the user/device may access, the levels of access to information supplied by the services, specify billing rates for specific services, etc.

When a user/device changes physical location as shown in FIG. 2, a device may make access to the hotspot service provider's network via a different access point 30. A similar handshaking process occurs with the new access point although as described above complete authentication will not be required as it operates as a hand-off of the device from one access point to another. Further, new location-based information may be requested or accepted selectively by the user/device or, in an embodiment, provided automatically, in either case using the same mechanisms described above based upon the access point the device is accessing.

In an embodiment, as the user/device, that has previously been provided location-based services for a nearest smoking lounge and continues to request or accept such services, changes location within an airport and makes at least one hand-off to another access point, the location-based services server(s) operates in conjunction with the location-based database(s) to narrow the list of available smoking lounges based upon the direction of travel of the user/device. By using the location of the previous access point with which the device registered and the location of the current location of the access point with which the device is registered, the location-based services can eliminate previously provided smoking lounges (if any) not nearest to the current access point compared to the previous access point and/or those that are not in the direction of travel of the device extrapolated from the previous access point to the current access point. In this embodiment, an assumption is made that the user/device continues in the direction of travel between the previous and current access points. As will be apparent to those skilled in the art, more sophisticated techniques could be used to narrow the list of smoking lounges relevant to the user/device direction of travel. For example, access point location history, if there was two or more hand-offs, can be used to determine a pattern for the direction of travel. Further, the physical limitations of the location where the user/device is located can be used to predict direction of travel e.g. the layout of the airport could constrain the direction of travel and thereby provide a good predictor of future direction of travel.

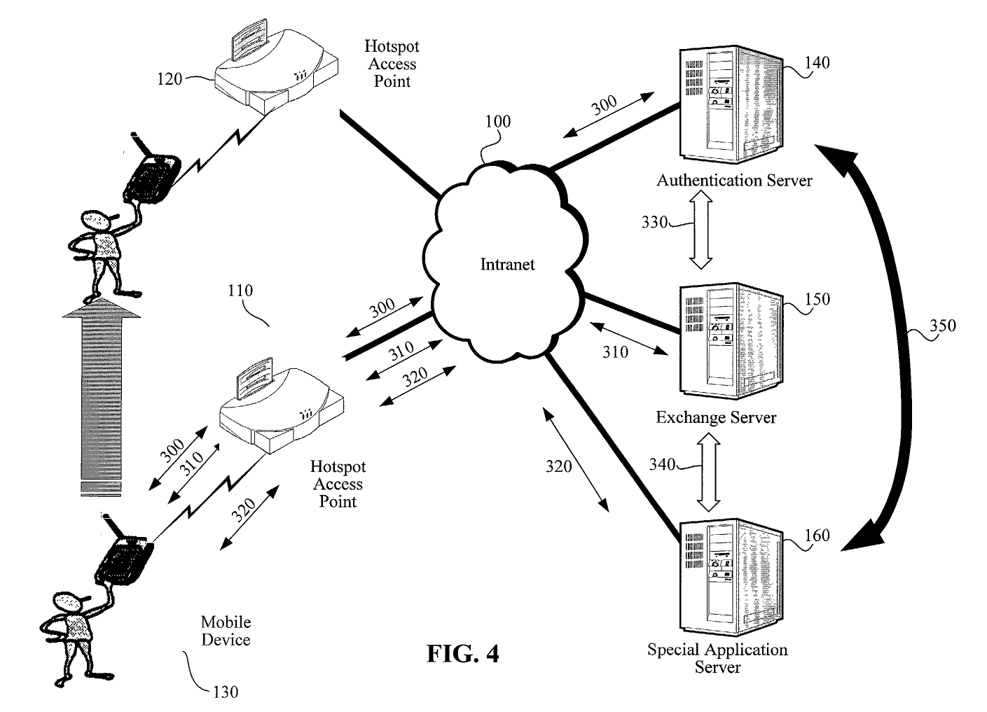

Referring to FIG. 4, a scenario of supplying location-based services along with associated data flows in accordance to the business embodiment of the invention is described. In this scenario, a user desires the cafeteria menu of the corporate cafeteria nearest to the user's present physical location although as should be apparent to those skilled in the art other location-based information (and any other perhaps non-location-based but relevant information) could be provided to the user/device. So, when the user/device enters the range of a hotspot access point 110, the operating device 130 discovers from transmissions emitted from the access point that the device may register for services supplied through the access point (equally the device could send out transmissions to which an access point could respond by accepting a request for or offering such services if authorized).

If the device is configured to register for such services (e.g. the device is authorized to access the services whether by the user or manufacturer of the device pre-configuring the device to request or accept all such services, a portion of such services depending on specific criteria or all or some of the services after inquiry of the user whether to request or accept all or specific services supplied), the device and the access point will begin handshaking 300 to establish a connection wherein the device and user is authenticated via the authentication server(s) 140 for access to the intranet. In an embodiment, a user/device is required to provide identification information such as a login name or employee ID to determine whether and what types of services may be provided and authentication information such as password to confirm proper usage of the device. As will be apparent to those skilled in the art, such identification and/or authentication information may be pre-configured into the device or may be selectively provided by the user of the device. Further, certain users/devices may be able to connect with and request or accept services from the intranet without identification and/or authentication such as visitors to a business facility that may be provided Internet access without requiring identification or authentication information. Optionally, some or all of the information exchanged during handshaking may be encrypted to protect identification and/or authentication information transmitted during handshaking. Upon authentication, subsequent handshaking of the device with another access point will not require the user/device to supply identification and/or authentication information for access to intranet services provided there is a current connection between the device and the intranet.

If the user/device is authenticated, there may also be provided one or more modes on the device or on the intranet for providing appropriate security. Based on the mode, an appropriate level of security may be provided. In an embodiment, unique user/device identification information (such as an International Mobile Subscriber Identity (IMSI) string used in mobile telephone networks or an employee identification number) is selectively associated with a mode by the user or the network (or perhaps automatically by default or based upon criteria) and each mode has its own routing identification (for example, a unique IP address for each mode). So, in operation, the user/device identification information identifies the desired security mode and upon identification of the relevant mode, communications are routed through the mode's unique IP address using appropriate security (e.g. encryption, firewalls, etc.) to the mode identified. In an embodiment, three modes are provided: a business or private mode wherein the high encryption is used to essentially create a virtual private network (VPN) and that would be most useful to business users/devices; a public mode wherein low security is provided and that would be most useful to business visitors; and a personal mode wherein low to medium security is provided depending on the usage of the connection (e.g. simple browsing vs. banking) and that would be most useful to employees or visitors for activities requiring some measure of security.

Similar to the public embodiment described above, usage of the services in the business embodiment may also be charged and billed through one or more billing servers (not shown in FIG. 2) perhaps depending on the type of user/device accessing the intranet and the types of services provided from the intranet. For example, certain connections with and services from the intranet may be charged on an accounting basis to a user/device's department within the business or a business visitor may be billed for private usage. Similarly, the intranet may recognize similar billing modes as described earlier and based on the mode, an appropriate party may be charged/billed. In an embodiment, unique user/device identification information (such as an International Mobile Subscriber Identity (IMSI) string used in mobile telephone networks) is selectively associated with a mode by the user or the intranet (or perhaps automatically by default or based upon criteria) and each mode has its own routing identification (for example, a unique IP address for each mode). So, in operation, the user/device identification information identifies the desired charging/billing mode and upon identification of the relevant mode, service usage is charged/billed according to a charging/billing profile that identifies the charged/billed party, charging/billing rates, etc.

Once authenticated and a connection is established with the intranet, one or more applications such as e-mail, calendars, task lists, etc. on the device may request or accept information 310 from one or more exchange servers 150 on the intranet. The authentication server(s) relays 330 user/device profile information to the exchange server(s) to determine the appropriate information to be sent to the user/device e.g. updated calendar information, new email, etc. and to authorize the sending of such application information. Such profile information details the services the user/device may access, the levels of access to information supplied by the services, etc. The application information is then downloaded 310 from the exchange server(s) to the device. Alternatively, application information may be pushed to the device based upon the user/device's profile information and applications available on the device. In this manner, one or more device applications are updated automatically by the downloading of application information to the device. In either scenario, application information may be selectively or automatically uploaded to the exchange server(s) for sending, modifying of application databases, etc.

The device can also request or accept 320 location-based services e.g. request the cafeteria menu of the nearest cafeteria to the user/device's physical location. In an embodiment, the user/device selectively chooses to receive location-based services. As should be apparent to those skilled in the art, the device may request and/or accept all or a portion of such services automatically or the services provided may be defined by profile information for the user/device maintained in the intranet, preferably the authentication server(s). Upon receiving the request or acceptance from the device for some or all location-based services or automatically in other circumstances, the special application server(s) 160 supplying location-based services identifies which access point the device is accessing and registers its location. In an embodiment, the request or acceptance along with the access point identification information (or in other cases simply the access point identification information) is then sent to the location-based services database(s) (which is optimally combined with the special application server(s)) to determine the nearest cafeteria(s) and its menu(s) (or other relevant location-based or perhaps non-location-based but relevant information) to the access point. The cafeteria menu(s) (or other) information is then downloaded 320 to the device where it may be displayed for the user or otherwise used by the device. Such information can include cafeteria menu text, photos of cafeteria menu items, location and hours of the cafeteria(s), events occurring near the cafeteria(s), etc. or perhaps other non-location based information such as business announcements. In an embodiment, the types of services including location-based services supplied to the device can be configured based on the user/device accessing the intranet through the exchange of profile information 340, 350 between the authentication/exchange server(s) and the special application server(s). For example, an employee user's profile information may designate the user's home facility so when the user/device visits another facility different location-based services may be provided than when the user/device is at the home facility. Such different services could include maps of the facility layout, locations of nearest cafeterias, etc. In an embodiment, such a user/device can selectively accept or request such services when at the other facility and modify the profile information to configure the different services that may be supplied.

When a user/device changes physical location as shown in FIG. 4, a device may make access to the intranet via a different access point 120. A similar handshaking process occurs with the new access point although as described above complete authentication will not be required as it operates as a hand-off of the device from one access point to another. Further, new location-based information may be accepted or requested selectively by the user/device or, in an embodiment, provided automatically, in either case using the same mechanisms described above based upon the access point the device is accessing.

In an embodiment, as the user/device, that has previously been provided location-based services for the cafeteria menu of a nearest cafeteria and continues to request or accept such services, changes physical location and makes at least one hand-off to another access point, the location-based services server(s) operates in conjunction with the location-based database(s) to narrow the list of available cafeterias and corresponding menus based upon the direction of travel of the user/device. By using the location of the previous access point with which the device registered and the location of the current location of the access point with which the device is registered, the location-based services can eliminate previously provided cafeterias and corresponding menus (if any) that are not in the direction of travel of the device from the previous access point to the current access point. In this embodiment, an assumption is made that the user/device continues in the direction of travel between the previous and current access points. As will be apparent to those skilled in the art, more sophisticated techniques could be used to narrow the list of smoking lounges relevant to the user/device direction of travel. For example, access point registration history, if there was two or more hand-offs, can be used to determine a pattern for the direction of travel. Further, the physical limitations of the location where the user/device is located can be used to predict direction of travel e.g. the layout of the facility in which the access point being accessed by the user/device is located could constrain the direction of travel and thereby provide a good predictor of future direction of travel.

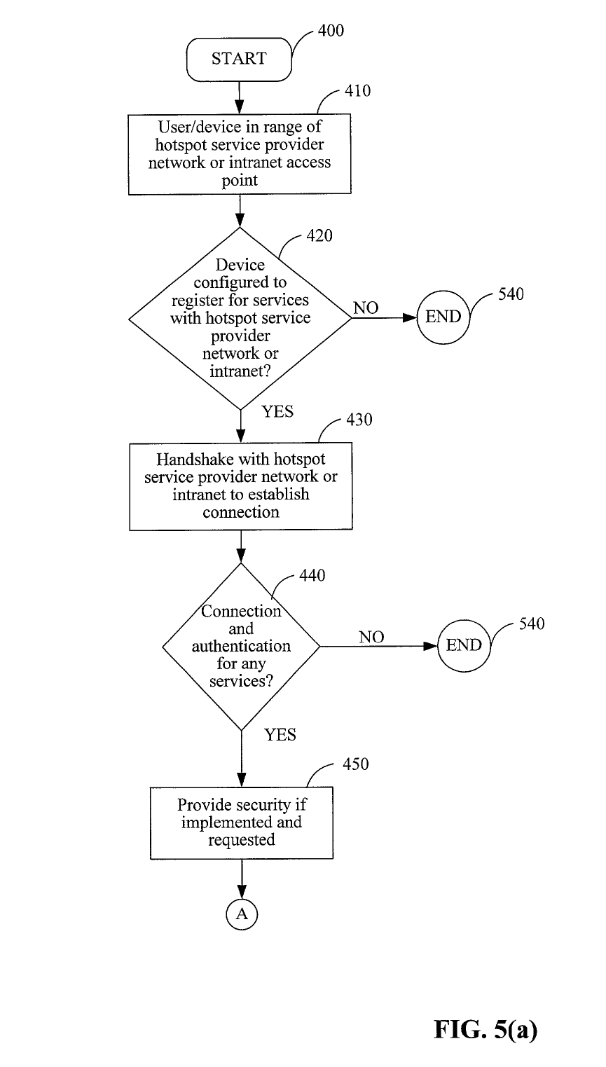

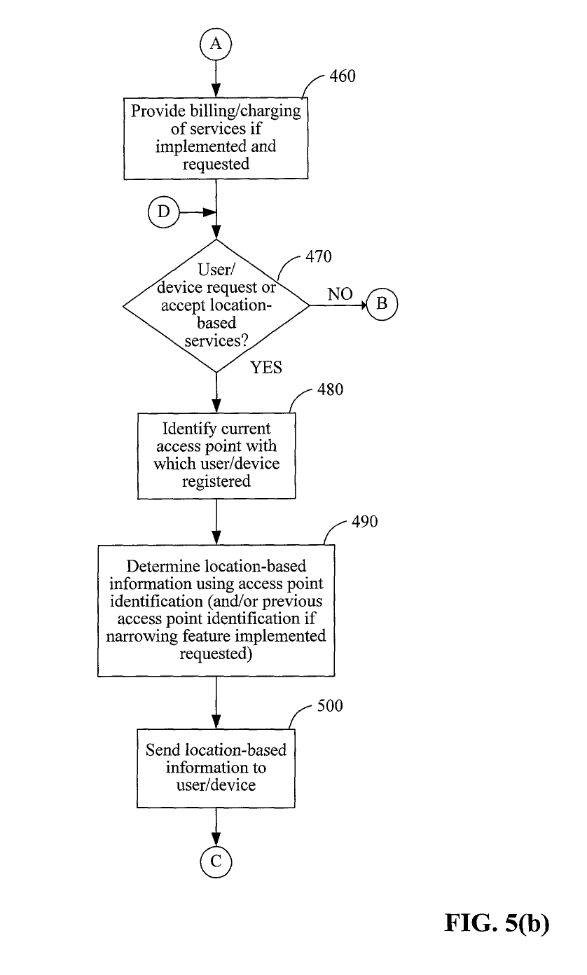

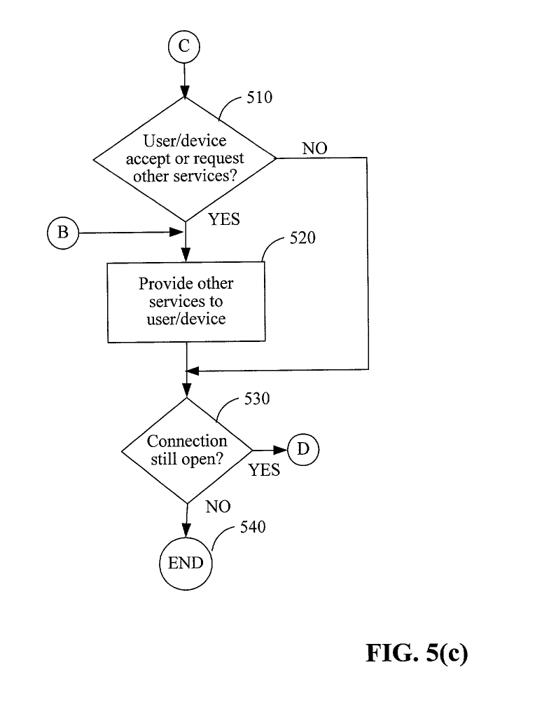

Referring to FIGS. 5(a), 5(b) and 5(c), a flow diagram illustrating in generalized fashion a method for providing location-based services according to embodiments of the invention is depicted. The diagram outlines generally the method of both the public and business embodiments of the invention described above.

The detailed descriptions may have been presented in terms of program procedures executed on a computer or network of computers. These procedural descriptions and representations are the means used by those skilled in the art to most effectively convey the substance of their work to others skilled in the art. The embodiments of the invention may be implemented as apparent to those skilled in the art in hardware or software, or any combination thereof. The actual software code or hardware used to implement the invention is not limiting of the invention. Thus, the operation and behavior of the embodiments often will be described without specific reference to the actual software code or hardware components. The absence of such specific references is feasible because it is clearly understood that artisans of ordinary skill would be able to design software and hardware to implement the embodiments of the invention based on the description herein with only a reasonable effort and without undue experimentation.

A procedure is here, and generally, conceived to be a self-consistent sequence of operations leading to a desired result. These operations comprise physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations of the invention described herein; the operations are machine operations. Useful machines for performing the operations of the invention include general purpose digital computers, special purpose computers or similar devices.

Each operation of the method may be executed on any general computer, such as a mainframe computer, personal computer or the like and pursuant to one or more, or a part of one or more, program modules or objects generated from any programming language, such as C++, Java, Fortran, etc. And still further, each operation, or a file, module, object or the like implementing each operation, may be executed by special purpose hardware or a circuit module designed for that purpose. For example, the invention may be implemented as a firmware program loaded into non-volatile storage or a software program loaded from or into a data storage medium as machine-readable code, such code being instructions executable by an array of logic elements such as a microprocessor or other digital signal processing unit. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on.

In the case of diagrams depicted herein, they are provided by way of example. There may be variations to these diagrams or theoperations described herein without departing from the spirit of the invention. For instance, in certain cases, the operations may be performed in differing order, or operations may be added, deleted or modified. An embodiment of the invention may be implemented as an article of manufacture comprising a computer usable medium having computer readable program code means therein for executing the method operations of the invention, a program storage device readable by a machine, tangibly embodying a program of instructions executable by a machine to perform the method operations of the invention, or a computer program product. Such an article of manufacture, program storage device or computer program product may include, but is not limited to, CD-ROM, CD-R, CD-RW, diskettes, tapes, hard drives, computer system memory (e.g. RAM or ROM), and/or the electronic, magnetic, optical, biological or other similar embodiment of the program (including, but not limited to, a carrier wave modulated, or otherwise manipulated, to convey instructions that can be read, demodulated/decoded and executed by a computer). Indeed, the article of manufacture, program storage device or computer program product may include any solid or fluid transmission medium, whether magnetic, biological, optical, or the like, for storing or transmitting signals readable by a machine for controlling the operation of a general or special purpose computer according to the method of the invention and/or to structure its components in accordance with a system of the invention.

An embodiment of the invention may also be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another apparatus (such as a cellular telephone).

The system may be specially constructed for the required purposes to perform, for example, the method of the invention or it may comprise one or more general purpose computers as selectively activated or reconfigured by a computer program in accordance with the teachings herein stored in the computer(s). The system could also be implemented in whole or in part as a hard-wired circuit or as a circuit configuration fabricated into an application-specific integrated circuit. The invention presented herein is not inherently related to a particular computer system or other apparatus. The required structure for a variety of these systems will appear from the description given.

While this invention has been described in relation to certain embodiments, it will be understood by those skilled in the art that other embodiments according to the generic principles disclosed herein, modifications to the disclosed embodiments and changes in the details of construction, arrangement of parts, compositions, processes, structures and materials selection all may be made without departing from the spirit and scope of the invention. Changes, including equivalent structures, acts, materials, etc., may be made, within the purview of the appended claims, without departing from the scope and spirit of the invention in its aspects. Thus, it should be understood that the above described embodiments have been provided by way of example rather than as a limitation of the invention and that the specification and drawing(s) are, accordingly, to be regarded in an illustrative rather than a restrictive sense. As such, the invention is not intended to be limited to the embodiments shown above but rather is to be accorded the widest scope consistent with the principles and novel features disclosed in any fashion herein.

What is claimed is:

1. A method of providing location-based services to a wireless device using a hotspot access point, comprising:
establishing a connection between the wireless device and the hotspot access point; and providing information associated with the physical location of the hotspot access point to the wireless device.

2. The method of claim 1, further comprising:
identifying the hotspot access point with which the wireless device is connected; and
determining information associated with the physical location of the access point using the identification of the hotspot access point in a look-up database.

3. The method of claim 1, further comprising providing security for the location-based services according to a mode of security, the mode having associated therewith routing identification information.

4. The method of claim 3, wherein the routing identification information is an IP address and providing security comprises routing the location-based services through the IP address using security identified with the mode.

5. The method of claim 1, wherein the access point is a wireless LAN access point device.

6. The method of claim 1, further comprising:
making a hand-off of the wireless device to an other hotspot access point;
narrowing the information provided to the wireless device with respect to the physical location of the hotspot access point based upon the direction of travel of the wireless device; and
providing the narrowed information associated with the physical location of the other hotspot access point to the wireless device.

7. The method of claim 1, further comprising providing synchronization of the wireless device to any one of an e-mail, calendar, task list or contact application associated with the user/device identification information.

8. A method of securing services provided through a hotspot access point, comprising:
establishing a connection between a wireless device and the hotspot access point;
determining user/device identification information associated with the wireless device;
identifying a mode of security for the services using the user/device identification information, the mode having associated therewith routing identification information; and
providing the services according to the mode of security using the routing identification information through the hotspot access point to the wireless device.

9. The method of claim 8, wherein the routing identification information is an IP address and providing the secure services comprises routing the services through the IP address according to the identified mode of security.

10. The method of claim 9, wherein the mode comprises any one of a private, public or personal mode.

11. A method of billing services provided through a hotspot access point, comprising:
establishing a connection between a wireless device and the hotspot access point;
determining user/device identification information associated with the wireless device; and
billing usage of the services through the access point by the wireless device according to a mode of billing identified by the user/device identification information.

12. The method of claim 11, wherein the mode comprises any one of a business, public or personal mode, wherein the private mode comprises billing a business entity other than an actual user of the wireless device or a service provider associated with the wireless device or the actual user of the wireless device, the public mode comprises billing the actual user of the wireless device, and the personal mode comprises billing the service provider associated with the wireless device.

13. A method of providing access to an application through a hotspot access point, comprising:
establishing a connection between a wireless device and the hotspot access point;
determining user/device identification information associated with the wireless device; and
synchronizing the wireless device to any one of an e-mail, calendar, task list or contact application associated with the user/device identification information.

14. The method of claim 13, further comprising providing information associated with the physical location of the hotspot access point to the wireless device.

15. A system of providing location-based services to a wireless device using a hotspot access point, comprising:
the hotspot access point to establish a connection between the wireless device and a hotspot access point network; and
location-based services server to provide information associated with the physical location of the hotspot access point to the wireless device.

16. The system of claim 15, wherein the location-based services server further identifies the hotspot access point with which the wireless device is connected and determines information associated with the physical location of the access point using the identification of the hotspot access point in a look-up database.

17. The system of claim 15, further comprising an authorization server to provide security for the location-based services according to a mode of security, the mode having associated therewith routing identification information.

18. The system of claim 17, wherein the routing identification information is an IP address and the authorization server facilitates routing the location-based services through the IP address using security identified with the mode.

19. The system of claim 15, wherein the access point is a wireless LAN access point device.

20. The system of claim 15, wherein the location-based services server:
makes a hand-off of the wireless device to an other hotspot access point;
narrows the information provided to the wireless device with respect to the physical location of the hotspot access point based upon the direction of travel of the wireless device; and
provides the narrowed information associated with the physical location of the other hotspot access point to the wireless device.

21. The system of claim 15, further comprising an exchange server to provide synchronization of the wireless device to any one of an e-mail, calendar, task list or contact application associated with the user/device identification information.

22. A computer program product including computer program code to cause a computer to perform a method of providing location-based services to a wireless device using a hotspot access point, the method comprising:
establishing a connection between the wireless device and the hotspot access point; and providing information associated with the physical location of the hotspot access point to the wireless device.

23. The computer program product of claim 22, the method further comprising:
identifying the hotspot access point with which the wireless device is connected; and
determining information associated with the physical location of the access point using the identification of the hotspot access point in a look-up database.

24. The computer program product of claim 22, the method further comprising providing security for the location-based services according to a mode of security, the mode having associated therewith routing identification information.

25. The computer program product of claim 24, wherein the routing identification information is an IP address and providing security comprises routing the location-based services through the IP address using security identified with the mode.

26. The computer program product claim 22, the method further comprising:
making a hand-off of the wireless device to an other hotspot access point;
narrowing the information provided to the wireless device with respect to the physical location of the hotspot access point based upon the direction of travel of the wireless device; and
providing the narrowed information associated with the physical location of the other hotspot access point to the wireless device.

27. A computer program product including computer program code to cause a computer to perform a method of securing services provided through a hotspot access point, the method comprising:
establishing a connection between a wireless device and the hotspot access point;
determining user/device identification information associated with the wireless device;
identifying a mode of security for the services using the user/device identification information, the mode having associated therewith routing identification information; and
providing the services according to the mode of security using the routing identification information through the hotspot access point to the wireless device.

28. The computer program product of claim 27, wherein the routing identification information is an IP address and providing the secure services comprises routing the services through the IP address according to the identified mode of security.

29. A computer program product including computer program code to cause a computer to perform a method of billing services provided through a hotspot access point, the method comprising:
establishing a connection between a wireless device and the hotspot access point;
determining user/device identification information associated with the wireless device; and
billing usage of the services through the access point by the wireless device according to a mode of billing identified by the user/device identification information.

30. The computer program product of claim 29, wherein the mode comprises any one of a business, public or personal mode, wherein the private mode comprises billing a business entity other than an actual user of the wireless device or a service provider associated with the wireless device or the actual user of the wireless device, the public mode comprises billing the actual user of the wireless device, and the personal mode comprises billing the service provider associated with the wireless device.
